(19) United States
(12) Patent Application Publication
(10) Pub. No.: US 2010/0207909 A1
(43) Pub. Date: Aug. 19, 2010

(54) DETECTION MODULE AND AN OPTICAL DETECTION DEVICE COMPRISING THE SAME

(76) Inventors: Ming-Cho Wu, Longtan Township (TW); Chui-Yao Chiu, Taipei City (TW); Ching-Hui Lin, Taoyuan City (TW); Hung-Ching Duan, Bade City (TW)

Correspondence Address: Muncy, Geissler, Olds & Lowe, PLLC, 4000 Legato Road, Suite 310, FAIRFAX, VA, 22033, US

(21) Appl. No.: 12/371,228

(22) Filed: Feb. 13, 2009

(51) Int. Cl. G06F 3/042; G01N 21/55; G01B 11/14

(52) U.S. Cl. 345/175; 356/445; 356/623

(57) ABSTRACT

Disclosed herein includes a module and an optical detection device comprising the same for determining a touch position on a screen caused by an object, such as a finger of a user or a stylus pen.

### BACKGROUND

1. Field of Invention

The present invention in general relates to a detection module and an optical detection device comprising the same.

2. Description of Related Art

A conventional optical detection device as part of a computer input system usually consists of several cameras or optical detectors arranged around a detection region, e.g. a display panel or a touch pad. For example, U.S. Pat. No. 7,414,617 B2 disclosed a coordinate input device that includes a pair of cameras positioned in an upper left position and an upper right position of a display screen of the monitor and views both a side face of an object in contact with a position on the display screen and a pre-determined desk-top coordinate detection area to capture the image of the object with the field of view. The position of the object on the display screen is calculated based on video signals output from the pair of cameras. In another example, US 2008/0259053 A1 suggested a touch screen system, in which several light sources are disposed along one edge of a display screen and three reflectors are respectively attached to the remaining three edges of the display screen for reflecting light such that the display screen can be scanned with light beams for detecting an object, e.g. a finger or a stylus, in touch with the display screen. A similar approach is also suggested in Taiwan Patent No. 496,965, in which an optical detection device equipped with a complicated light-emitting unit, an image detection unit arranged along one edge of a display screen and three reflectors respectively attached to the remaining three edges of the display screen is disclosed. In all these cases, four edges of the display screen are either occupied by cameras, optical detectors, optical lens or reflectors. In other words, the structure of the optical detection device suggested in the prior art is complicated, and therefore is more expensive to manufacture or maintain. Hence, there exist in this art an improved optical detection device that is easy to use and more economically to implement as part of a computer input system.

### SUMMARY

It is an object of this invention to provide a module and an optical detection device comprising the same.

According to an aspect of the present invention, there is provided a module of an optical detection device, the module includes: a light-generating unit and a detection unit. The light-generating unit includes a light source and a first lens. The light source is to emit a collimated light beam. The first lens is associated with the light source for transforming the collimated light beam into a sheet of light in a detection region. The detection unit includes a detector and a second lens. The detector is to detect a reflected light beam generated by an object in the detection region. The second lens is associated with the detector for forming an image of the object onto the detector. The light-generating unit and the detection unit are oriented approximately towards the detection region.

According to another aspect of the present invention, there is provided an optical detection device, which includes: two modules as described and a processing unit. Each module is oriented toward the detection region and separated from each other by a distance. Each module includes a light-generating unit and a detection unit. The light-generating unit includes a light source and a first lens. The light source is to emit a collimated light beam. The first lens is associated with the light source for transforming the collimated light beam into a sheet of light in a detection region. The detection unit includes a detector and a second lens. The detector is to detect a reflected light beam generated by an object in the detection region. The second lens is associated with the detector for forming an image of the object onto the detector. The light-generating unit and the detection unit are oriented approximately towards the detection region. The processing unit is operable to determine a position of the object in the detection region based on two angles formed among the position of the object in the detection region and positions of the two modules by way of triangulation.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates the spatial arrangement of two modules around a detection region in accordance with one preferred embodiment of this invention;

FIG. 2 illustrates the detection of two position signals on the linear sensor, each signal is an indicative of a touch position of a finger on the detection region;

FIG. 3 illustrates angles formed between the object in the detection region and two detection units according to a preferred embodiment of this invention; and

FIG. 4 illustrates a perspective view of an optical detection device implemented on a notebook computer according to one embodiment of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description, to refer to the same or like parts.

The invention provides an optical detection device to be implemented on a display panel, a touch pad and so on. The optical detection device is useful for determining a touch position on a screen caused by an object, such as a finger of a user or a stylus pen.

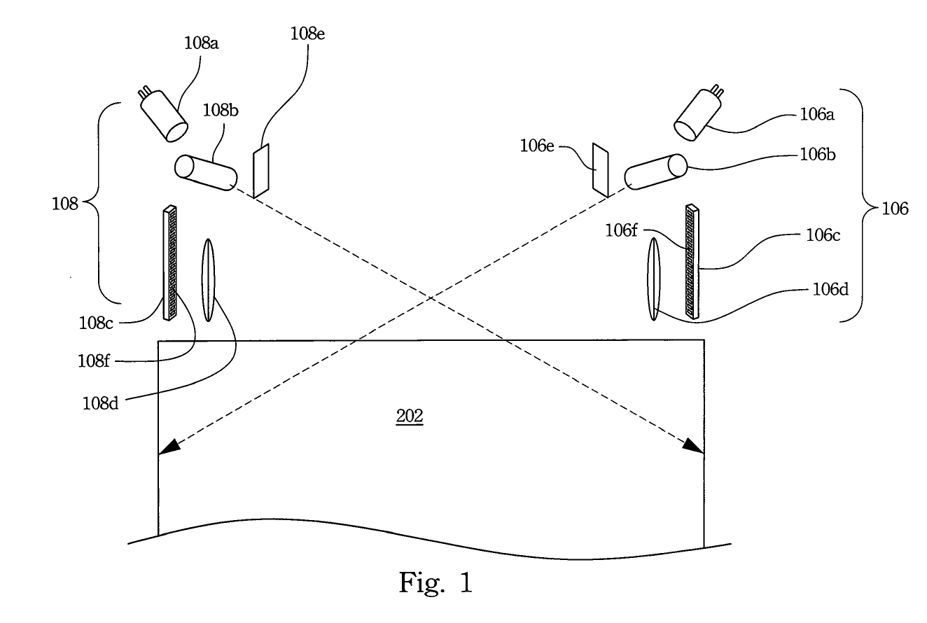

The present invention therefore features a module of an optical detection device for easy determination of a touch position on a display panel or a screen. The module comprises a light-generating unit and a detection unit. At least two modules are required for determining the touch position caused by the object in a detection region, i.e., the display panel or the screen. FIG. 1 illustrates the spatial arrangement of two modules around a detection region. As illustrated in FIG. 1, each of the two modules (106, 108) is disposed at one upper corner along an edge of the display screen 202 and is oriented toward a detection region, i.e., the display screen 202. The two modules (106, 108) are therefore separated from each other by a distance, e.g., approximately the length of an edge of the display screen 202 in this embodiment. Each module is oriented approximately towards the detection region such that the light-generating unit emits light towards the detection region and the detection unit detects light reflected from the detection region.

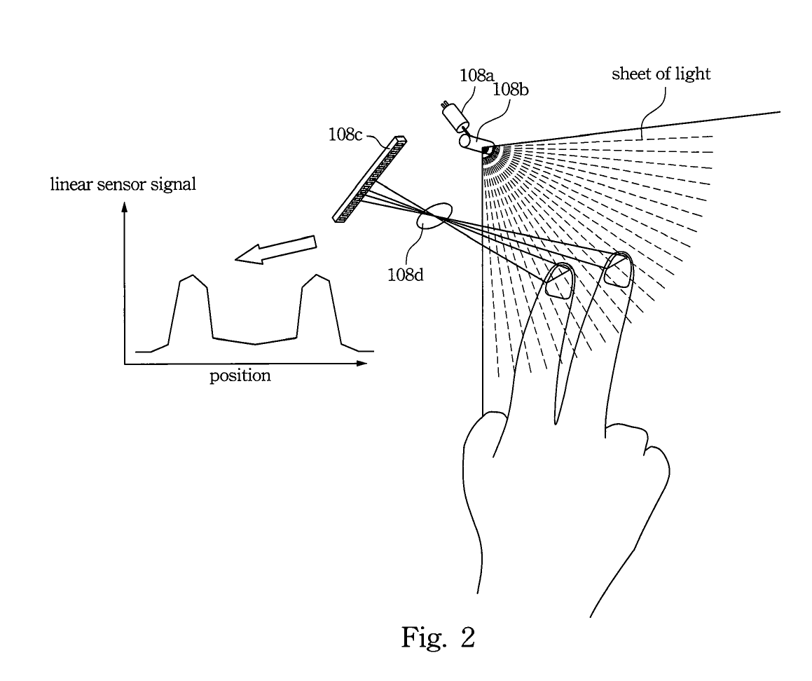

The light-generating unit includes a light source (106a or 108a) and a first lens (106b or 108b). The light source (106a or 108a) is to emit a collimated light beam with high directionality. Preferred light source (106a or 108a) includes a laser, such as an infrared laser diode for generating an infrared laser of 780 nm, 808 nm or 850 nm in wavelength. The first lens (106b or 108b) is associated with the light source (106a or 108a), preferably in front of the light source (106a or 108a), for transforming the collimated light beam into a sheet of light in the detection region (as illustrated in FIG. 2). The sheet of light runs in a substantially parallel relationship above the display screen 202. The first lens (106b or 108b) may be a line-generating lens, which includes, but is not limited to, a cylindrical lens. However, it is to be understood that any lens that may transform a collimated light beam into a sheet of light is suitable for practicing this invention. In another example, the line-generating lens may be rotated or swiveled rapidly across the detection region so as to scan the detection region with the sheet of light. In other example, each light-generating unit may further include a light shield (106e or 108e) to prevent the sheet of light from being incident onto the detection unit of the other module disposed at the opposite corner of the display screen 202. For example, the light shield 106e is to prevent light beam emitted from the light source 106a from being incident onto the detection unit of the module 108, while the light shield 108e is to prevent the light beam emitted from the light source 108a from being incident onto the detection unit of the module 106.

The detection unit includes a detector (106c or 108c) and a second lens (106d or 108d). The detector (106c or 108c) can be a linear Complementary Metal-Oxide Semiconductor (linear CMOS) or a linear Charge-Coupled Device (linear CCD), which detects a reflected light beam generated by the touch on the screen caused by the object in the detection region. The second lens (106d or 108d) is associated with the detector (106c or 108c), preferably in front of the detector (106c or 108c), for forming an image of the object onto the detector. The second lens (106d or 108d) may be a convex lens or a compound lens. In this embodiment, the second lens is a convex lens. Each detection unit may further include an infrared long pass filter (106f or 108f) associated with the detector (106c or 108c) for eliminating visible light. The infrared long pass filter (106f or 108f) permits the infrared light of more than 750 nm in wavelength to pass and incident onto the detector (106c or 108c). In this example, the light source (106a or 108a) is an infrared laser diode for generating an infrared laser of 850 nm in wavelength, such that the detector (106c or 108c) would not be interfered by the ambient light. In an alternate embodiment (not illustrated in the drawings), the infrared long pass filter may be a coating on the second lens (106d or 108d) or an optical filter located between the second lens (106d or 108d) and the detector (106c or 108c).

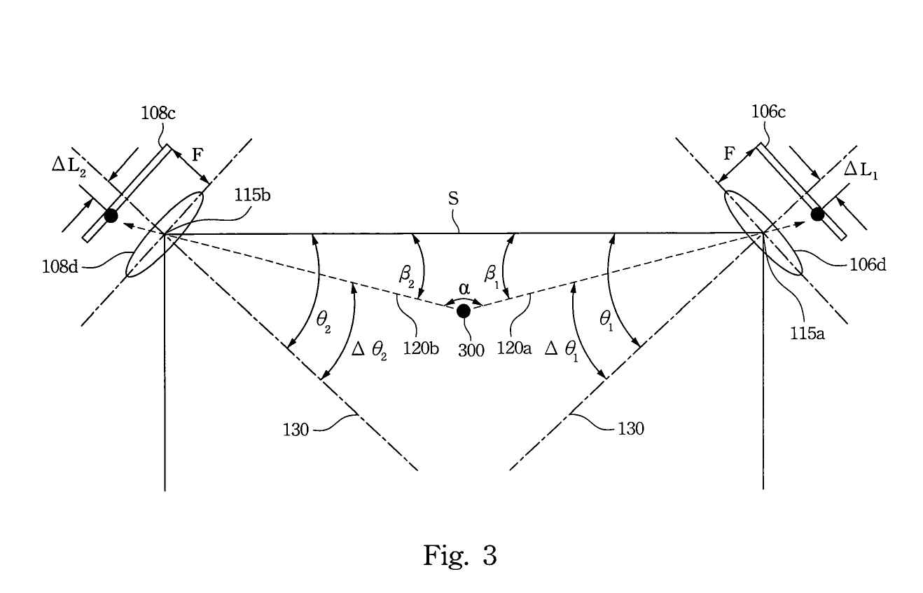

When an object, e.g., a finger of a user or a stylus, within the detection region touches the display screen 202, the incident sheet of light beam hits the object and is therefore reflected by the object and subsequently forms an image on the detector of the detection unit of the module, and the position signal of the image is thus collected. FIG. 2 illustrates two position signals detected by the linear sensor, with each position an indicative of a touch position of the object in the detection region. The position signal is then used to determine the touch position of the object (e.g., a finger) on the display screen 202 in accordance with angles formed among the position of the object in the detection region and positions of the two detection units by way of triangulation (FIG. 3).

FIG. 3 illustrates angles formed between the object in the detection region and two detection units according to a preferred embodiment of this invention. As illustrated in FIG. 3, reference points 115a (the center of the second lens 106d) and 115b (the center of the second lens 108d) are pre-determined and hereby defined as the distance (S) between the two reference points (115a and 115b). When a reflected light beam (120a or 120b) generated by the touch of the object 300 pass through the second lens (106d or 108d), an image of the object is formed on the detector (106c or 108c). The position of the image formed on the linear sensor is herein defined as the distance (ΔL₁ or ΔL₂), which varies with the touch position caused by the object when it moves across the display panel. The touch position caused by the object 300 is then determined by angles (α, β₁ and β₂) formed among the touch position of the object in the detection region and positions of the two detection units by way of triangulation. The angle βₙ is calculated by the following equation (1):

βₙ=θₙ−Δ θₙ (1) (n=1 or 2)

in which angle θₙ is the angle between the distance (S) and the axis 130 of the second lens (106d or 108d); and angle Δ θₙ is the angle between the object 300 and the axis 130 of the second lens (106d or 108d). It is to be noted that angle Δ θₙ varies with the movement of the object across the display panel, hence, angle Δ θⁿ is further determined by the position signals (ΔLₙ, n=1 or 2) collected on the linear sensor and is calculated by the following equation (2)

Δ θₙ=arctangent of (ΔLₙ/F) (2)

in which F is the focal length of the second lens. Once angle βₙ is determined accordingly, the touch position of the object may be easily determined by a processing unit (not shown) operable to process position signals (ΔLₙ) collected from the detectors (106c or 108c) and the calculated angle βₙ by way of triangulation. The processing unit may be a processor plus a suitable software application, which is operable to determine the position of the object in a detection region in according to procedures described above.

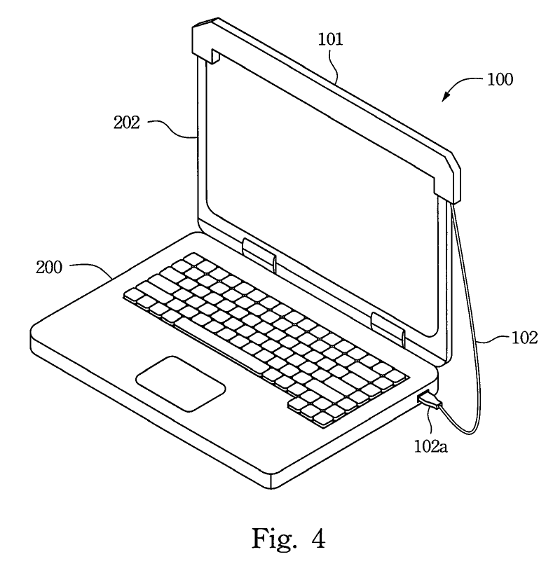

FIG. 4 is a perspective view of an optical detection device implemented on a notebook computer according to one embodiment of this invention. The optical detection device 100 includes a housing 101 for housing at least two modules (106, 108) of this invention and a processing unit (not shown), and is detachably mounted onto a display screen 202 of a notebook computer 200, e.g., an upper edge of the display screen 202. However, it is to be understood that the optical detection device 100 may be mounted onto any one of the four edges of the display screen, as long as accurate detection of a touch position made by an object on the screen is allowed. A power or signal cable 102, which includes a connector 102a, e.g., a USB connector, at one end, is plugged into a corresponding slot of the notebook computer 200; whereas the opposite end of the power or signal cable 102 is electrically connected to various components (as illustrated in FIG. 1) inside the housing 101, such that the device 100 is supplied with power and the touch position calculated in accordance with procedures described above is subsequently transmitted to the notebook computer 200. In an alternate embodiment (not illustrated in the drawings), the optical detection device is built into or is integrated into the display panel or a touch pad.

According to the embodiments discussed above, the present invention provides a module and an optical detection device comprising the same to detect and locate a touch position of an object on a display panel. The optical detection device is less complex in structure than any conventional optical detection device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A module for an optical detection device, comprising:
a light-generating unit, comprising:
a light source for emitting a collimated light beam; and
a first lens associated with the light source for transforming the collimated light beam into a sheet of light in a detection region; and
a detection unit, comprising:
a detector for detecting a reflected light beam generated by an object in the detection region; and
a second lens associated with the detector for forming an image of the object onto the detector;
wherein the light-generating unit and the detection unit are oriented approximately towards the detection region.

2. The module of claim 1, wherein the first lens is a line-generating lens or a cylindrical lens.

3. The module of claim 1, wherein the second lens is a convex lens or a compound lens.

4. The module of claim 1, wherein the light source is an infrared laser diode.

5. The module of claim 1, wherein the detection unit further comprises an infrared long pass filter for eliminating visible light.

6. The module of claim 1, wherein the detector is a linear sensor selected from a group consisting of a linear CMOS and a linear CCD.

7. The module of claim 1, wherein the object is a finger of a user or a stylus.

8. The module of claim 1, wherein the detection region is located on a display panel or a touch pad.

9. An optical detection device, comprising:
two modules of claim 1, with each module being oriented toward the detection region and separated from each other by a distance; and
a processing unit being operable to determine a position of the object in the detection region based on two angles formed among the position of the object in the detection region and positions of the two modules of claim 1 by way of triangulation.

10. The optical detection device of claim 9, wherein the two angles are produced from signals collected from the detectors, in which the signals are indicatives of the position of the object in the detection region when the sheet of light is reflected by the object and thereby forming the image of the object onto the detector.

11. The optical detection device of claim 9, wherein the device is detachably mounted onto a display panel or a touch pad.

12. The optical detection device of claim 9, wherein the device is integrated into the display panel or a touch pad.

13. The optical detection device of claim 9, wherein the light source is an infrared laser diode.

14. The optical detection device of claim 13, wherein the detection unit further comprises an infrared long pass filter for eliminating visible light.

15. The optical detection device of claim 9, wherein the distance equals to a length between two centers of the second lenses of the two modules.
